(19) United States
(12) Patent Application Publication
(10) Pub. No.: US 2017/0149658 A1
(43) Pub. Date: May 25, 2017

(54) Apparatus and Method for Forwarding Messages

(71) Applicant: Telefonaktiebolaget LM Ericsson (publ), Stockholm (SE)

(72) Inventors: Thomas Rimhagen, Linköping (SE); Piergiuseppe Di Marco, Sollentuna (SE); Jingcheng Zhang, Norrköping (SE)

(73) Assignee: Telfonaktiebolaget LM Ericsson (PUBL), Stockholm (SE)

(21) Appl. No.: 15/114,625

(22) PCT Filed: Jul. 1, 2016
(86) PCT No.: PCT/SE2016/050682

§ 371 Date: Jul. 27, 2016

Related U.S. Application Data
(60) Provisional application No. 62/188,937, filed on Jul. 6, 2015.

(51) Int. Cl. H04L 12/721; H04L 12/725; H04W 4/00; H04W 40/26; H04L 12/741

(52) U.S. Cl. CPC H04L 45/32; H04W 40/26; H04L 45/745; H04W 4/005; H04L 45/306; H04W 84/18

(57) ABSTRACT

A method in a relay device for forwarding messages in a mesh based network comprises receiving a message to be forwarded (step 201), and determining whether the message is to be forwarded using a routing profile associated with the message (step 203). If so, the message is routed according to a routing profile (step 205). If not, the message is outed using a flood procedure (step 207).

### TECHNICAL FIELD

The present disclosure relates to an apparatus and method for forwarding messages (also referred to herein as packets), and in particular to an apparatus and method for forwarding messages in a flooding-based mesh network, for example using a routing profile.

### BACKGROUND

In a mesh networking environment, a mesh network consists of machine devices, for instance sensors and actuators, and relay devices, which have the capability to forward packets. Mesh network topologies can be used by low power wireless communication technologies to increase the coverage and flexibility. Such topologies require devices to act as forwarders of packets. As a result, a packet from a source may reach its destination via several other devices that receive the packet and transmit it again.

One example of performing retransmissions is to broadcast the packets. Every device that receives a packet will forward the packet. Restrictions on the number of such transmissions can be applied, in order to avoid loops with infinite retransmissions. This technique, called flooding, is used in computer networking and it has been proposed to support mesh networking for wireless communication technologies such as Bluetooth Low Energy (BLE). This method requires no routing information or scheduling, and is resistant to changes in the topology. Also, this approach fits well with the characteristics of devices in low power networks, which are usually constrained in terms of memory and computational resources.

A more complex way of delivering packets through multi-hop networks is routing. Routing implies unicast transmissions between devices along a route from a source to destination. Therefore, in a routing network, the devices need to be able to find routes towards a given destination, to choose one of the routes according to some metrics and conditions, to encapsulate routing information into the packet (either specifying each device along the route or using an addressing system). One of the advantages of a routing network is that packets are sent on one route from the source to the destination and only devices on that route are involved in forwarding the packet. This means that unnecessary packets created in the network can be avoided, the interference is reduced and the network throughput will increase.

### SUMMARY

According to a first aspect, there is provided a method in a relay device for forwarding messages in a mesh based network. The method comprises receiving a message to be forwarded, and determining whether the message is to be forwarded using a routing profile associated with the message. If so, the message is routed according to a routing profile. If not, the message is forwarded using a flood procedure.

This has an advantage of being able to use routing when possible, but flooding in other circumstances. For example, the embodiments herein allow the coexistence of a routing profile application and other application profiles, which can potentially increase the network throughput by using different routing protocols, and thus not necessarily having to use flooding all the time.

According to another aspect, there is provided a method in a relay device for forwarding messages in a mesh based network. The method comprises receiving a message to be forwarded, and determining whether a routing indicator is set in the received message. If so, a routing procedure is used to forward the message. If not, a flood procedure is used to forward the message.

According to the embodiment above, an explicit routing indicator is therefore used to control whether or not routing, or another mechanism is to be used.

According to another aspect, there is provided a method in a network node for generating messages for forwarding via a mesh network. The method comprises generating a message, and inserting routing information into the message. The routing information enables a subsequent node to determine whether the message is to be forwarded according to a routing profile associated with the message, or forwarded using a flood procedure.

According to another aspect, there is provided a relay device for use in a mesh network. The relay device comprises a processor and a memory, said memory containing instructions executable by said processor. Said relay device is operative to receive a message to be forwarded, and determine whether the message is to be forwarded using a routing profile associated with the message. If so, the message is routed according to the routing profile. If not, the message is forwarded using a flood procedure.

According to another aspect, there is provided network node for use in a mesh network. The network node comprises a processor and a memory, said memory containing instructions executable by said processor. The network node is operative to generate a message, and insert routing information into the message, the routing information enabling a subsequent node to determine whether the message is to be forwarded according to a routing profile associated with the message, or forwarded using a flood procedure.

### BRIEF DESCRIPTION OF THE DRAWINGS

For a better understanding of the examples described herein, and to show more clearly how the examples may be carried into effect, reference will now be made, by way of example only, to the following drawings in which:

FIG. 1a shows an example of a send and receive flow for an application message;

FIG. 1b shows an example of a protocol data unit, PDU;

FIG. 2a shows an example of a method according to an embodiment;

FIG. 2b shows an example of a method according to an embodiment;

FIG. 2a shows an example of a method according to an embodiment;

FIG. 3 shows an example of a routing protocol interface according to an embodiment;

FIG. 4 shows an example of a method according to an embodiment;

FIG. 5 shows an example of a method according to an embodiment;

FIG. 6 shows an example of a method according to an embodiment;

FIG. 7 shows an example of a method according to an embodiment;

FIG. 8 shows an example of a relay device according to an embodiment; and

FIG. 9 shows an example of a network node according to an embodiment.

### DETAILED DESCRIPTION

In the description herein, it is noted that references to messages are intended to be used interchangeably with packets.

Existing short range radio technologies such as Bluetooth and ZigBee define communication protocols based on application profiles. As an example, to use the Bluetooth wireless technology, a device needs to be able to interpret certain Bluetooth profiles. Bluetooth profiles are definitions of possible applications and they specify general behaviours that Bluetooth-enabled devices use to communicate with other Bluetooth devices. There is a wide range of Bluetooth profiles describing many different types of applications or use cases for devices (e.g., Proximity Profile, Heart Rate Profile).

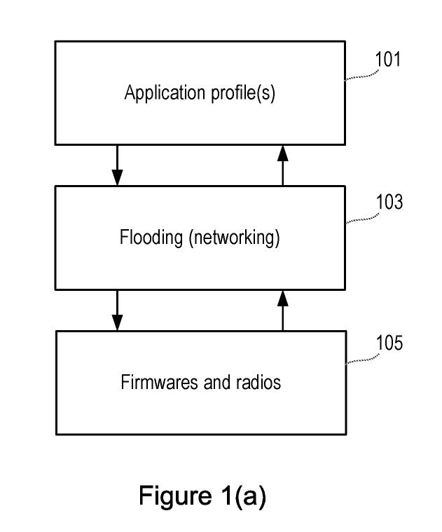

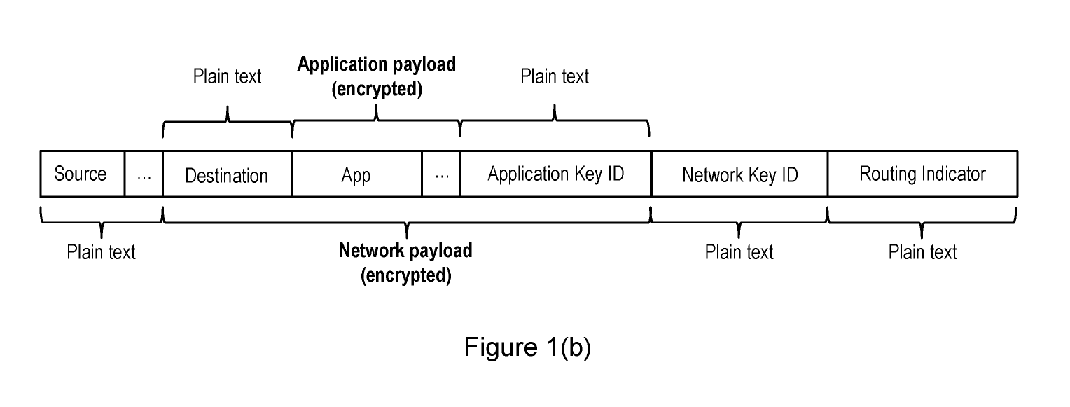

FIG. 1a shows one example where application profiles operate above a default message forwarding mechanism, e.g., flooding in this example. FIG. 1a shows the send and receive flows for an application message. Here, the application messages do not need to specify network related information in a message, for example a Protocol Data Unit (PDU), since the flooding algorithm will populate the message to each node within the network. These three blocks are a simplified representation of the Open Systems Interconnection (OSI) protocol stack. The application profile(s) block 101 generates messages that are sent to a networking layer 103, which takes care of disseminating the information (end-to-end, e.g. by flooding). The firmwares and radios block 105 is a representation of lower layer functionalities (e.g. channel access, physical transmission, radio propagation, etc.) that realize the networking (flooding) layer 103. The return flow from the firmwares and radios block 105 to the networking layer 103 is associated, for example, with a successful physical reception of a packet. The return flow from the networking layer 103 to the application profile(s) block 101 is associated, for example, to the correct authentication and decryption of the information.

An application payload is sent in messages, in one or, possibly segmented into, several PDUs. Each PDU contains fields, for example fields that are non-encrypted (“plain text”) and fields that are optionally signed and encrypted. Here, there is both a network part and an application part. These parts can only be decrypted if a receiver has the right keys.

FIG. 1b shows an example of a PDU. The field Application Key ID is optional. If not present, the receiver needs to try all known application keys in an exhaustive search.

When security is enabled, the application related data is signed and encrypted by a so called application key which could only be decrypted by the peer application (in the destination device) several hops away (using the same key). Similarly, the network payload is signed and encrypted by a so called network key. Both keys are distributed to all devices in advance. Additionally, as the keys are sometimes very long (many bits) a shorter “pointer” called Key ID can be used.

The Key ID may be associated to the key used for authentication (signing) and/or encryption of the payload of the message, and shared among devices. Moreover, in the alternatives of Embodiment B and Embodiment C of the examples described later in the application, it is noted that the Key ID may be used in the network layer to identify if a message is generated within a Routing Profile according to an embodiment. In this case, the application payload may come from any other profile. A network key associated to the Routing Profile may be distributed in the network (including to devices that do not implement the Routing Profile) and can be used for authentication and/or encryption of the mesh message payload.

Flooding has been originally designed for spreading information over all devices in the network. However, when flooding is used as a means of point-to-point communication, a network can quickly become saturated, since flooding requires all relays to forward the message if the relay has not done so. This disadvantage of flooding is more of an issue in a low throughput mesh-network, since most of the messages being relayed are not actually helping towards the forwarding of the message from the source to the destination, but still, the unnecessary packets will cause interference on the air.

Additionally, some networks based on using a flooding algorithm do not reserve any address field to enable routing. For example, a message that assumes to be populated by a flooding algorithm just specifies the source and destination address.

The embodiments described herein propose a method that provides routing as an application in a flooding-based network. Different from other applications, the routing applications according to the present embodiments can help the devices to find the route to the given destination address. When another application wishes to send messages to the destination, the message can be forwarded according to the route created by the routing application.

According to one example, the proposed routing application is implemented as a Routing Profile in an application layer, for example which runs on top of a flooding-based mesh-network. When forwarding a message, the application has the opportunity to select which method should be used to forward the message to the destination, either flooding or routing (possibly one of several routing protocols).

In an embodiment comprising a routing-enabled relay, a decision is taken whether the packet shall be forwarded or not, and if the packet shall be forwarded, which method shall be used. In one example, this forwarding decision is based on information retrieved from the PDU, using for example one of the following alternative solutions:

### Embodiment A

In one embodiment an indicator field is added to the message, for example added to the PDU, indicating “use routing” and for example which routing protocol to use;

### Embodiment B

In another embodiment an existing Network Key ID field is used to determine whether routing shall be used or not. For example, if the Key ID is associated with the Network Key of the Routing Profile application, then routing is to be used. In other words, a message which is signed by the network key of the Routing Profile is to use routing;

### Embodiment C

In another embodiment, optionally, the alternative in Embodiment B above can be improved by adding a field for Application Key ID, associated with the application key used (by the application—not the Routing Profile application. In other words, an application that wishes to send messages from a source to a destination, for example a key associated to a specific application that sends a message, e.g. for lighting or ventilation control, rather than the Routing Profile application per se).

It is noted that other embodiments or solutions may also be used to realise the invention as defined in the appended claims.

Additionally, the compatibility with non-routing enabled relays is considered in the methods described herein, and how non-routing enabled relays can co-exist with routing-enabled relays according to the embodiments described herein, and how they will continue to forward packets using flooding.

The embodiments described herein have an advantage of providing the possibility of coexistence of a Routing Profile application and other application profiles, which could potentially increase the network throughput by using different routing protocols, and thus not necessarily having to use flooding all the time.

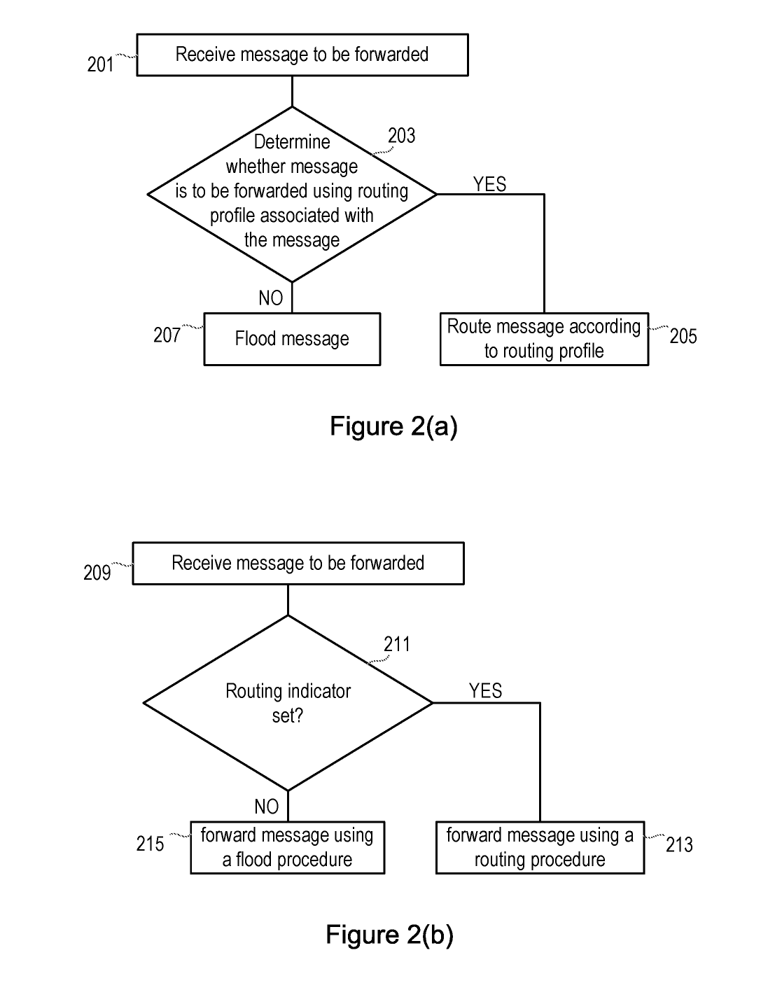

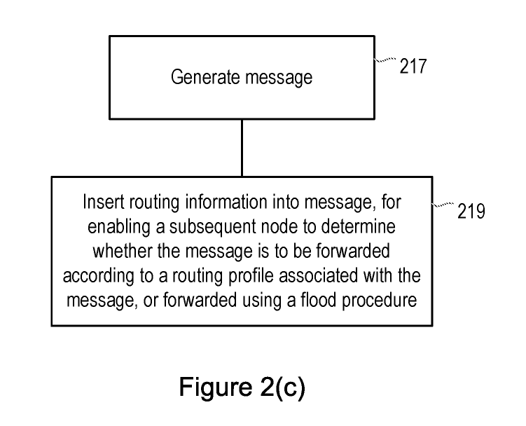

FIG. 2a shows an example of a method according to an embodiment, for example in a relay device for forwarding messages in a mesh based network. The method comprises receiving a message to be forwarded, step 201. In step 203 it is determined whether the message is to be forwarded using a routing profile associated with the message. If so, the message is routed according to the routing profile, step 205. If not, the message is forwarded using a flood procedure 207.

Thus, according to one example there is provided a method in a relay device for forwarding messages in a mesh based network. The method comprises receiving a message to be forwarded, and determining whether the message is to be forwarded using a routing profile associated with the message. If so, the message is routed according to a routing profile, and if not, the message is forwarded using a flood procedure.

In one example, the method comprises receiving, during a previous network communication, an application key and/or a network key relating to the routing profile. The application key and/or network key relating to the routing profile (routing application), enable the relay device to send/relay/receive the routed packets (messages).

In one example, the step of determining whether a message is to be forwarded using a routing profile associated with the message comprises determining whether a routing indicator is set in the received message. The routing indictor may comprise, for example, an enabling flag, for example comprising at least one control bit for indicating whether a message is to be forwarded according to a routing protocol or by flooding.

In an alternative example, the method further comprises the step of using a network key identifier (Network Key ID) in the received message, for example an existing network key identifier, to determine whether the message is to be forwarded using a routing profile associated with the message.

For example, the method may comprise the step of determining whether the network key identifier (Network Key ID) is associated with a network key of a routing profile application, and if so, routing the message according to the routing profile application. If the network key identifier (Network Key ID) is not associated with a network key of a routing profile application, the method may comprise discarding the message.

In some examples, the method further comprising using an application key identifier (Application Key ID) associated with the application key used for the message, to determine whether the message is to be forwarded using routing or flooding.

In one example the method comprises determining whether a destination address field specified in the message exists in a routing table, and if so, routing the message according to a routing profile, and if not, discarding the message.

FIG. 2b shows a method in a relay device according to another example, for example corresponding to Embodiment A mentioned above, for forwarding messages in a mesh based network. The method comprises receiving a message to be forwarded, step 209. In step 211 it is determined whether a routing indicator is set in the received message. If so, a routing procedure is used to forward the message, step 213. If not, a flood procedure is used to forward the message. As mentioned earlier, the routing indictor may comprise, for example, an enabling flag, for example comprising at least one control bit for indicating whether a message is to be forwarded according to a routing protocol or by flooding.

In the examples of FIGS. 2a and 2b, the relay device may comprise, for example, a machine device, machine communication device, machine-to-machine device, a terminal or wireless device, or user equipment.

FIG. 2c shows an example of a method in a network node according to another embodiment, for generating messages for forwarding via a mesh network. The method comprises generating a message, step 217. Step 219 comprises inserting routing information into the message, the routing information enabling a subsequent node to determine whether the message is to be forwarded according to a routing profile associated with the message, or forwarded using a flood procedure.

In one example, for example corresponding to Embodiment A, the step of inserting routing information comprises inserting or adding a routing indicator field to the message. For example, the routing indicator field may comprise at least one control bit for indicating to a subsequent node whether a routing procedure or flooding procedure is to be used for forwarding the message.

In some examples, the routing indicator field is further used to indicate to a subsequent node which routing protocol to use, for example which routing protocol from a set of possible routing protocols.

According to another example, for example corresponding to Embodiment B, the step of inserting routing information in FIG. 2c comprises inserting a network key identifier associated with a routing protocol application into an existing network key identifier field (Network Key ID) of the message.

According to another example, for example corresponding to Embodiment C, the step of inserting routing information in FIG. 2c comprises inserting a field for an application key identifier (Application Key ID) into the message, the application key identifier associated with the application key used by an application.

In the embodiments of FIGS. 2a to 2c, it is noted that a message may comprise a protocol data unit, PDU.

The examples of the embodiments described herein may therefore use either a new indicator (Embodiment A) or an existing network key (e.g. Key ID) to identify the routing method (Embodiment B) or an application key identifier (Embodiment C). These embodiments have the effect of separating the application layer and message forwarding layer.

The embodiments described herein have an advantage of keeping the same performance as flooding-based forwarding, when forwarding a non-routing enabled message, but avoid forwarding wasteful messages when routing enabled messaging is possible.

In embodiments described herein, a Routing Profile may define application layer routing control messages. In one example a Routing Profile is specified by:
A routing profile identifier (ID)
A set of operation codes.
A set of parameters, for example, application data.

In one example the routing profile identifier (ID) is unique for the application and it is used to identify if the message is a routing control message. In one example the operation codes are associated but not limited to the following operations: neighbour request, neighbour response, route discovery, route response, and presence announcement. In one example the parameters field is used to specify further details or procedures associated to the operations. The routing control messages may be sent in the application payload.

In one embodiment the routing control messages are sent along the network by devices implementing the Routing Profile and used to build routing tables. During the commissioning of the network, the application key and the network key of the Routing Profile is distributed to devices, for example all devices, including devices that are non-routing enabled. This way, all devices have the keys required to send/relay/receive the routed packets.

In one example a routing table contains a list of addresses of routing-enabled devices and for each address, route metrics and flags indicating whether or not to relay messages with a destination field matching that address.

The way of populating the routing table can be based, for example, on the reception of routing control messages, and it is not defined by the embodiments described herein. Existing mechanisms, such as Ad hoc On-Demand Distance Vector routing can be used.

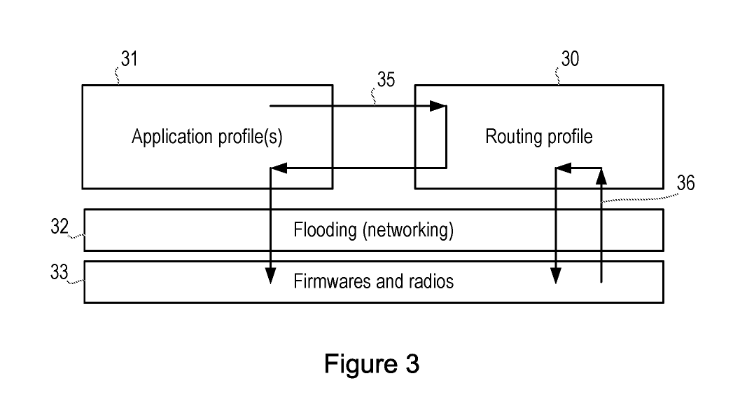

FIG. 3 shows an example of an embodiment, and in particular how a routing profile 30 can interact with different applications. As mentioned earlier, the blocks 30/31, 32, 33 are a simplified representation of the Open Systems Interconnection (OSI) protocol stack. The application profile(s) blocks 30/31 generate messages that are sent to a networking layer 32, which takes care of disseminating the information (end-to-end, e.g. by flooding). The firmwares and radios block 33 is a representation of lower layer functionalities (e.g. channel access, physical transmission, radio propagation, etc.) that realize the networking (flooding) layer 32.

Generally, there are three features of a routing profile according to this embodiment, those being:
create route on demand;
generating routing enabled message; and
relay routing enabled message.

In some examples, a fourth feature may comprise route maintenance, for example detecting broken routes and re-creating them, if any.

When an application starts operating, the application registers its address of interest to the routing profile. The routing profile then starts working on creating the route for the assigned address.

As an example, applicable to the alternative of Embodiment B and Embodiment C, when an application wants to send a message with routing enabled, it asks the routing profile for the network keys that uniquely identifies the routing profile, as shown by the set of arrows 35 in FIG. 3. When a message with routing profile network key assigned is received by the relay, the message is forwarded according to the created route saved in the routing profile, as shown by the set of arrows 36 in FIG. 3.

With regard to the behaviour of routing-enabled devices, in one embodiment a routing-enabled device is able to create, maintain, and repair routes towards other routing-enabled devices.

A routing-enabled device knows the application key and the network key associated to the Routing Profile (for example having received these previously during a network commissioning procedure, or through some other method). The device is able to generate, read, and, modify routing control messages.

Upon receiving a message which is to use routing, the device checks the destination field in the network layer. If the device is the destination of the message (or if it is a broadcast message), the device checks the application payload. If it is not the destination, the device checks, for example in the routing table, if the destination is known. The message is then forwarded according to the routing table.

Upon receiving a message which is not to use routing, the device checks the destination field in the network layer. If the device is the destination of the message (or if it is a broadcast address), the device checks the application payload. If it is not the destination, the device uses the default forwarding mechanism (e.g., flooding).

With regard to the behaviour of non-routing-enabled devices, the following may apply. A non-routing-enabled device in the context of the embodiments described herein is a device that belongs to the same network, but a device that does not support the Routing Profile. It is desirable for compatibility to allow for the presence of such devices in the network. These devices do not know the application key associated to the Routing Profile, but in some embodiments they are informed about the network key used by the Routing Profile.

Thus, upon receiving a message signed with a Routing Profile network key, such a device checks the destination field at the network layer. If the device is the destination of the message (or if it is a broadcast message), the device checks the application payload. Otherwise, it uses the default message forwarding mechanism, e.g., flooding.

Upon receiving a message signed with a different network key, the device checks the destination field at the network layer. If the device is the destination of the message (or if it is a broadcast message), the device checks the application payload. If it is not the destination, the device uses the default forwarding mechanism (e.g., flooding).

It is noted that mesh topologies in which embodiments of the present invention may be used, are presently under standardisation, and differ from existing ways of BLE communication. Typically, an application profile and related data is exchanged between peer devices using Bluetooth Low Energy (BLE) data channel communication, whereby first and second devices are involved in this communication as a master and slave. Embodiments of the flooding and routing message forwarding mechanism described herein is related with multi-hop networks that may include more devices. It is noted that in the mesh network being standardised, there are also application layer “profiles” defined, however, these applications are not related to the network message forwarding methods described herein.

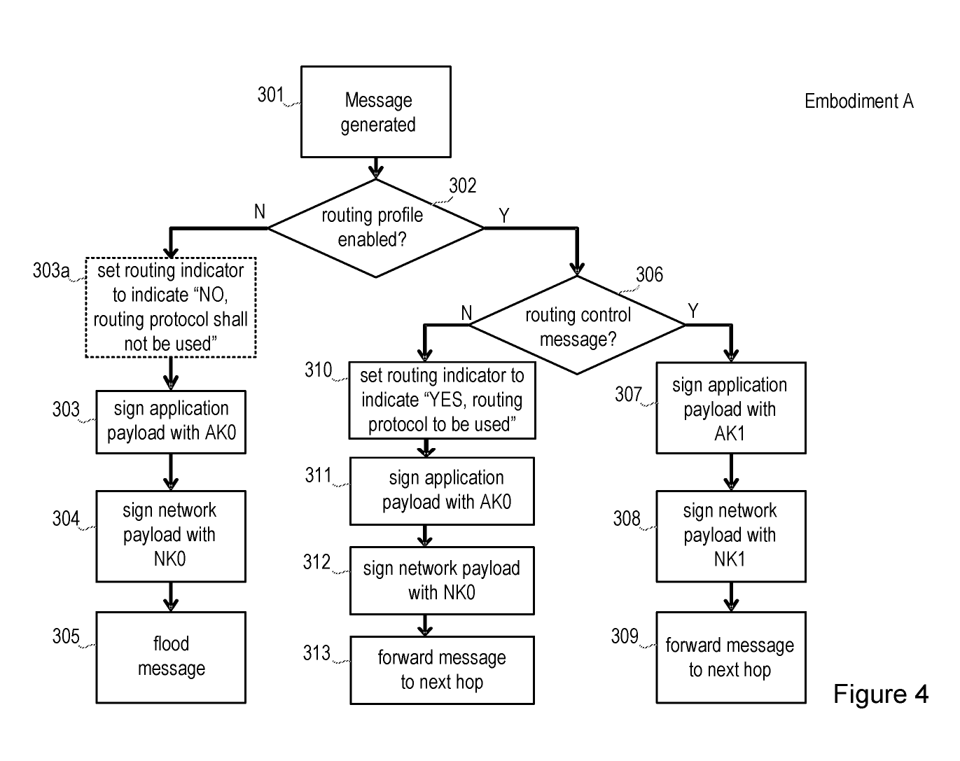

Next there will be described examples of a message forwarding state machine. FIGS. 4 to 7 show examples of the network key assignment and message forward method according to various embodiments. It is assumed that an application has the corresponding application key AK0 and network key NK0 while the routing profile according to the embodiments herein has the application key AK1 and network key NK1.

FIG. 4 is an example showing a message network key assignment process for the example of Embodiment A described above. As shown in FIG. 4, the message is signed with AK0 and NK0 if the application does not want to use the routing profile to forward the message. The routing indicator is set in the message if the application wants to use the routing profile to forward the message. The Routing Profile uses the message with AK1 and NK1 to forward routing control messages. It is noted that routing control messages are sent, for example, in one hop.

In more detail, step 301 shows a message being generated. In step 302 a check is performed to determine if a routing profile is to be enabled. If not, the application payload is signed with AK0, step 303, the network payload signed with NK0, step 304, and the message flooded, step 305. In some embodiments, prior to steps 303, 304 and 305, the method may comprise setting a routing indicator to indicate “NO, routing protocol shall not be used”.

If it is determined in step 302 that routing profile is to be enabled, in step 306 it is determined whether a message is a routing control message. If not, in step 310 a routing indictor is set, for example to indicate “YES, routing protocol to be used”. The application payload is signed with AK0, step 311, the network payload signed with NK0, and the message forwarded to the next hop, step 313. If it is determined in step 306 that the message is a routing control message, in step 307 the application payload is signed with AK1, the network payload signed with NK1 in step 308, and the message forwarded to the next hop in step 309.

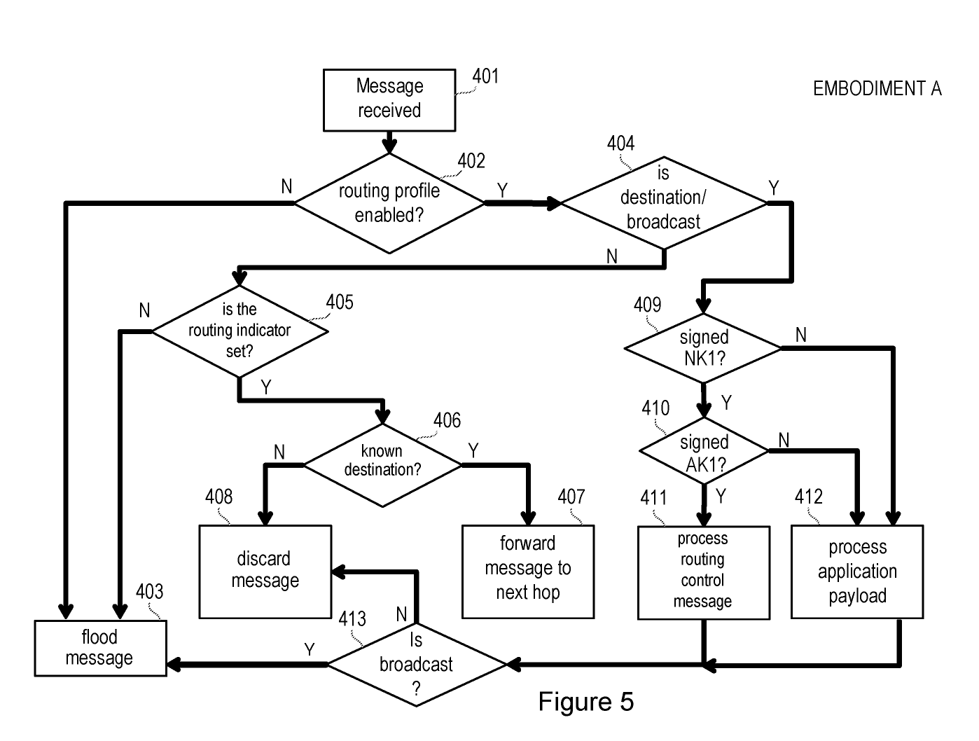

FIG. 5 is another example showing a message forward procedure for the example of Embodiment A. FIG. 5 shows the message receiving process. When a relay is not enabled with Routing Profile, the received message will be forwarded using flooding. Otherwise, if the received message does not have the routing indicator set, the message is also flooded. If a message with the routing indicator set is received by a routing enabled relay, the relay will check if the destination address field specified in the message exists in its routing table. If so, the message is forwarded using routing, otherwise, the message is simply discarded.

In more detail, according to one example step 401 shows a message being received. In step 402 a check is performed to determine if a routing profile is enabled in the received message. If not, a flood message procedure is performed, step 403. If it is determined in step 402 that routing profile is enabled, in step 404 it is determined if the relay device (i.e. that has received the message and performing this method) is a destination relay device, or if the received message is a broadcast message (for example by determining if a destination address field specified in the message exists in a routing table). If not (i.e. this is not the destination relay device, and/or the message is not a broadcast message), it is determined in step 405 whether a routing indictor is set. If not, a flood message procedure is performed, step 403. If it is determined in step 405 that the routing indicator is set, in step 406 it is determined if the destination is known (for example determining if a destination address field specified in the message exists in a routing table). If not, the message is discarded, step 408. If it is determined in step 406 that the destination is known, the message is forwarded to the next hop, step 407. If the outcome of step 404 is “YES” (e.g. because this is the destination relay device), it is determined in step 409 if the message is signed with NK1. If not, the application payload is processed, step 412. If it is determined in step 409 that the message is signed with NK1, it is determined in step 410 whether the message is signed AK1. If not, the application payload is processed, step 412. If it is determined in step 410 that the message is signed with AK1, the routing control message is processed, step 411.

It is noted that, in examples where a routing indicator is used, it is not necessarily required that two different network keys NK0 and NK1 are used. For example, NK0 and NK1 could be the same in such a scenario, and whereby step 308 of FIG. 4 would change to “sign network payload with NK1”, while step 409 of FIG. 5 would not be needed.

After steps 412 and 411, in one example the method may further comprise determining if a broadcast is required, step 413. If so, the message is flooded, step 403. If not, the message is discarded, step 408.

Next there will be described more details of alternative embodiments, and in particular examples relating to Embodiment B and Embodiment C mentioned earlier.

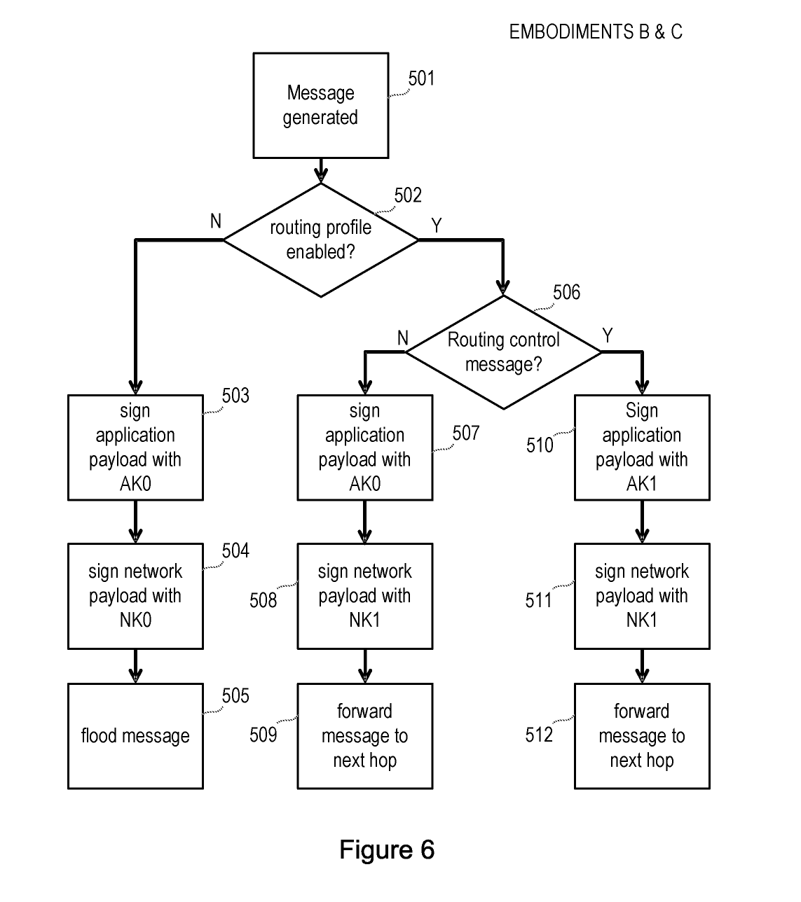

FIG. 6 shows an example of a message network key assignment process for the examples of Embodiment B and Embodiment C. As shown in FIG. 6, the message is signed with AK0 and NK0 if the application does not want to use the Routing Profile to forward the message. The message is signed with AK0 and NK1 if the application wants to use the routing profile to forward the message. The Routing Profile uses the message with AK1 and NK1 to forward routing control messages.

In more detail, step 501 shows a generated message. In step 502 a check is performed to determine if a routing profile is to be enabled in the generated message. If not, the application payload is signed with AK0, step 503, the network payload signed with NK0, step 504, and a flood message procedure is performed, step 505.

If it is determined in step 502 that routing profile is to be enabled, in step 506 it is determined whether the message is a routing control message. If not, the application payload is signed with AK0, step 507, the network payload signed with NK1, step 508, and the message forwarded to the next hop, step 509. If it is determined in step 506 that the message is a routing control message, the application payload is signed with AK1, step 510, the network payload signed with NK1, step 511, and the message forwarded to the next hop, step 512.

FIG. 6 therefore describes the various scenarios for generating a message, according to whether a flooding procedure or routing procedure is to be used downstream, and according to whether or not a message is a routing control message.

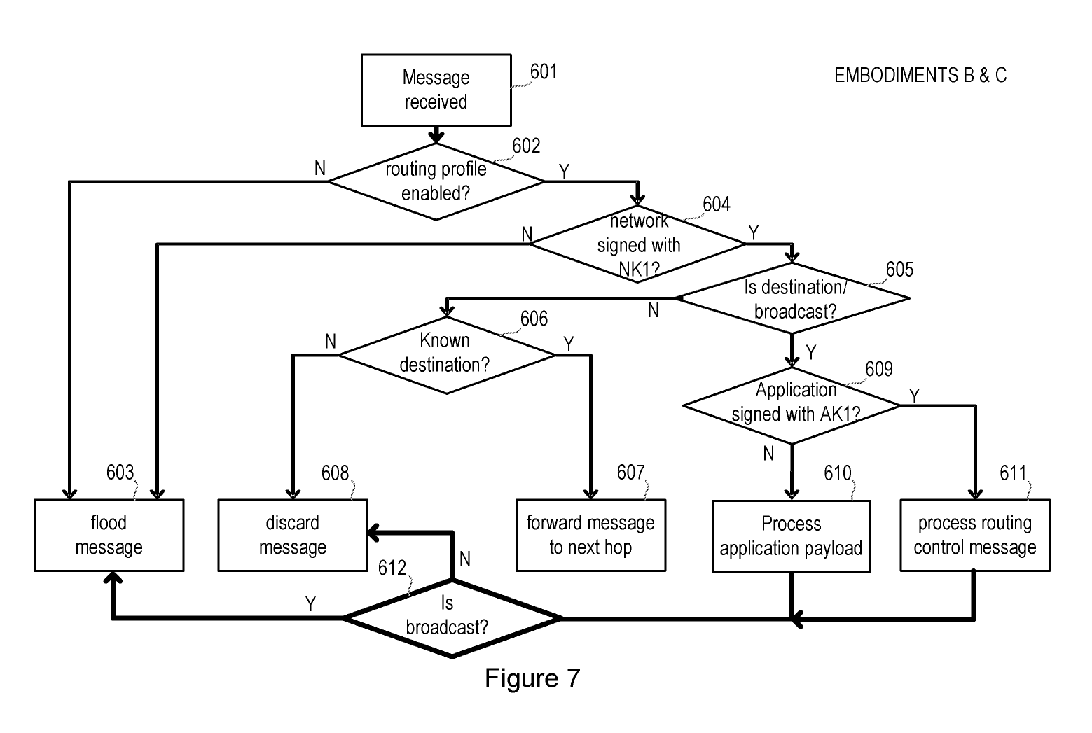

FIG. 7 shows an example of a message forward procedure for the examples according to Embodiment B and Embodiment C. FIG. 7 shows the message receiving process for such embodiments, for example as performed in a relay device. When a relay device is not enabled with the Routing Profile, the received message could be simply flooded. Otherwise, if the received message is utilizing the network key other than NK1, the message is also flooded. If the message signed with NK1 is received by a routing enabled relay, the relay will check if the destination address field specified in the message exist in its routing table. If so, the message is forwarded, otherwise, the message is simply discarded.

In more detail, according to one example step 601 shows a message being received. In step 602 a check is performed to determine if a routing profile is enabled in the relay device, for example according to whether the relay device is a legacy device or not. If a routing profile is not enabled (for example because the relay device is a legacy device), a flood message procedure is performed, step 603. If it is determined in step 602 that routing profile is enabled, in step 604 it is determined whether a network payload is signed with NK1. In other words, the method comprises using a network key identifier (Network Key ID, NK1) in the received message to determine whether the message is to be forwarded using a routing profile associated with the message. If not, a flood message procedure is performed, step 603. If it is determined in step 604 that the network payload is signed with NK1, in step 605 it is determined if the destination is broadcast (for example determining if a destination address field specified in the message exists in a routing table). It is noted that a broadcast address may have a different format with respect to a unicast address, such that a node can therefore identify a broadcast destination by reading the address field in the message. If it is determined in step 605 that the destination is not a broadcast, it is determined in step 606 if the destination is known. If not, the message is discarded, step 608. If it is determined in step 606 that the destination is known, i.e. in the routing table, in step 607 the message is forwarded to the next hop. If the outcome of step 605 is “yes”, in step 609 it is determined whether the application is signed with AK1. If not, the application payload is processed, step 610. If it is determined in step 609 that the application is signed with AK1, then in step 611 the routing control message is processed, i.e. processed at the relay device in view of the determination that the relay device is the destination node of that message.

After steps 610 and 611, in one example the method may further comprise determining if a broadcast is required, step 612. If so, the message is flooded, step 603. If not, the message is discarded, step 608.

The embodiments described herein provide routing opportunities as an application profile, which can increase the network throughput in a flooding-based mesh-network.

With regard to the embodiments above it can be seen that, with the routing control messages, in some embodiments they are always sent using AK1/NK1 from the routing application itself. These are control messages used to discover new routes, report route metrics etc. In one example, these messages are sent on one hop, but they could also be broadcasted (flooded). This is why the routing indicator is not set in this case.

In embodiments relating to the example of Embodiment A, they signal explicitly that routing is to be used (by the routing indicator, e.g. a new specific routing indicator provided for this purpose), thus both AK0/NK0 from the application itself can be used. In embodiments relating to the alternative example of Embodiment B, the Network Key ID is used to identify routing usage, thus NK1 is used. To find the App Key, the receiver will need to perform an exhaustive search. Thus, in the examples relating to Embodiment C, they also use NK1 to indicate routing, but they explicitly signal App Key ID to simplify for the receiver and to improve performance.

According to another embodiment, there is provided a method of configuring a message, the method comprising: signing an application payload and network payload with first respective keys (AK0, NK0) relating to a first application if a flood forwarding procedure is to be used for forwarding the message; and signing an application payload and network payload with second respective keys (AK1, NK1) relating to a routing application, if a routing protocol is to be used for forwarding the message.

According to another embodiment there is provided an application profile for defining a communication protocol in a short range radio communication system, (for example Bluetooth or ZigBee), the application profile comprising a routing profile, for routing messages within the short range radio communication system.

According to one embodiment, there is provided a method of routing messages in a mesh network, the method comprising using an application in a flooding-based network, wherein the application comprises a routing application for routing a message. In one example the routing application comprises a routing profile.

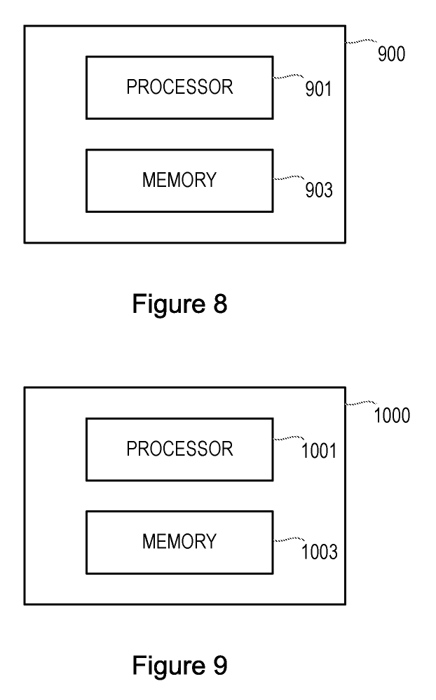

FIG. 8 shows an example of a relay device 900 according to an embodiment, for use in a mesh network. The relay node comprises a processor 901 and a memory 903, said memory 903 containing instructions executable by said processor 901.

In one embodiment, said relay device 900 is operative to: receive a message to be forwarded, determine whether the message is to be forwarded using a routing profile associated with the message, and if so, route the message according to the routing profile, and if not, forward the message using a flood procedure.

In one embodiment, said relay device 900 is operative to: receive, during a previous network communication, an application key and/or a network key relating to the routing profile. The application key and network key relating to the routing profile (routing application), enable the relay device to send/relay/receive the routed packets (messages).

In one embodiment, said relay device 900 is operative to receive a message to be forwarded, determine whether a routing indicator is set in the received message, and if so, use a routing procedure to forward the message, and if not use a flood procedure (i.e. broadcast procedure) to forward the message.

In the example of FIG. 8, the relay device 900 may comprise, for example, a machine device, machine communication device, machine-to-machine device, or another terminal or wireless device, or user equipment.

In one embodiment, said relay device 900 is operative to select whether to use a flooding protocol or a routing protocol, and forwarding the message using the selected protocol. In one example the routing protocol is selected from one of a plurality of different routing protocol options.

In one embodiment, said relay device 900 is operative to determine if a routing application is associated with the packet to be forwarded, and, if so, forward the packet using a routing protocol instead of a flooding protocol.

FIG. 9 shows a network node 1000 for use in a mesh network. The network node comprises a processor 1001 and a memory 1003, said memory 1003 containing instructions executable by said processor 1001.

In one embodiment, said network node 1000 is operative to: generate a message, and insert routing information into the message, the routing information enabling a subsequent node to determine whether the message is to be forwarded according to a routing profile associated with the message, or forwarded using a flood procedure.

In one embodiment, said network node 1000 is operative to insert routing information comprising an indicator field (for example a routing indicator) added to the message. The routing indicator can indicate to a subsequent node to use routing, and may also indicate which routing protocol to use.

In one embodiment, said network node 1000 is operative to insert routing information comprising an existing network key identifier field (Newport Key ID), which is used to indicate to a subsequent node to use routing. For example, if a Key ID is associated with the network key of the routing protocol application, then routing is to be used.

In one embodiment, said network node 1000 is operative to insert routing information comprising an existing network key identifier field (Newport Key ID), which is used to indicate to a subsequent node to use routing. For example, if a Key ID is associated with the network key of the routing protocol application, then routing is to be used. In the example, a field is added for Application Key ID associated with the application key used (by the application, rather than the routing profile application).

In one embodiment, said network node 1000 is operative to sign an application payload and network payload with first respective keys (AK0, NK0) relating to a first application if a flood forwarding procedure is to be used for forwarding the message; and sign an application payload and network payload with second respective keys (AK1, NK1) relating to a routing application, if a routing protocol is to be used for forwarding the message.

According to one method in a relay device, there is provided a method of forwarding a message, the method comprising: selecting whether to use a flooding protocol or a routing protocol, and forwarding the message using the selected protocol. In one example the routing protocol is selected from one of a plurality of different routing protocol options.

According to another embodiment there is provided a method in a relay device configured for performing a flooding protocol for forwarding packets in a mesh network, the method comprising: determining if a routing application is associated with the packet to be forwarded, and, if so, forwarding the packet using a routing protocol instead of a flooding protocol.

According to another embodiment there is provided a routing profile for use in a flooding-based mesh network comprising a plurality of mesh devices.

The embodiments described above have the advantage of providing routing as an application in a flooding-based network. Different from other applications, the routing applications according to the present embodiments can help the devices to find the route to the given destination address. When another application wishes to send messages to the destination, the message can be forwarded according to the route created by the routing application.

The embodiments described herein provide a hybrid networking mechanism, whereby the advantages of flooding and routing are exploited. Nodes that do not implement mesh routing can still use flooding when forwarding messages. In addition, a particular node or relay device can dynamically switch between using routing or flooding to forward packets, for example using a routing indicator, such as an enabling flag, provided within a message.

It should be noted that the above-mentioned embodiments illustrate rather than limit the invention, and that those skilled in the art will be able to design many alternative embodiments without departing from the scope of the appended claims. The word “comprising” does not exclude the presence of elements or steps other than those listed in a claim, “a” or “an” does not exclude a plurality, and a single processor or other unit may fulfil the functions of several units recited in the claims. Any reference signs in the claims shall not be construed so as to limit their scope.

1-20. (canceled)

21. A method in a relay device for forwarding messages in a mesh based network, the method comprising:
receiving a message to be forwarded;
determining whether the message is to be forwarded using a routing profile associated with the message; and if so,
routing the message according to a routing profile, and if not,
forwarding the message using a flood procedure.

22. The method of claim 21, wherein the method comprises receiving, during a previous network communication, an application key and/or a network key relating to the routing profile.

23. The method of claim 21, wherein the step of determining whether a message is to be forwarded using a routing profile associated with the message comprises determining whether a routing indicator is set in the received message.

24. The method of claim 21, further comprising:
using a network key identifier in the received message to determine whether the message is to be forwarded using a routing profile associated with the message.

25. The method of claim 24, further comprising the step of determining whether the network key identifier is associated with a network key of a routing profile application, and if so, routing the message according to the routing profile application.

26. The method of claim 25, further comprising using an application key identifier associated with an application key used for the message, to determine whether the message is to be forwarded using routing or flooding.

27. The method of claim 21, further comprising:
determining whether a destination address field specified in the message exists in a routing table; and if so,
routing the message according to a routing profile; and if not, discarding the message.

28. The method of claim 21, wherein the relay device comprises a machine device, machine communication device, machine-to-machine device, a terminal or wireless device, or user equipment.

29. A method in a relay device for forwarding messages in a mesh based network, the method comprising:
receiving a message to be forwarded;
determining whether a routing indicator is set in the received message; and if so,
using a routing procedure to forward the message: and if not,
using a flood procedure to forward the message.

30. A method in a network node for generating messages for forwarding via a mesh network, the method comprising:
generating a message;
inserting routing information into the message, the routing information enabling a subsequent node to determine whether the message is to be forwarded according to a routing profile associated with the message, or forwarded using a flood procedure.

31. The method of claim 30, wherein the step of inserting routing information comprises inserting a routing indicator field in the message.

32. The method of claim 31, wherein the routing indicator field comprises at least one control bit for indicating to a subsequent node whether a routing procedure or flooding procedure is to be used for forwarding the message.

33. The method of claim 32, wherein the routing indicator field is further used to indicate to a subsequent node which routing protocol to use.

34. The method of claim 30, wherein the step of inserting routing information comprises inserting a network key identifier associated with a routing protocol application into an existing network key identifier field of the message.

35. The method of claim 34, wherein the step of inserting routing information further comprises inserting a field for an application key identifier into the message, the application key identifier associated with an application key used by an application.

36. The method of claim 21, wherein a message comprises a protocol data unit.

37. A relay device for use in a mesh network, the relay device comprising a processor and a memory, said memory containing instructions executable by said processor, wherein said relay device is operative to:
receive a message to be forwarded;
determine whether the message is to be forwarded using a routing profile associated with the message; and if so,
route the message according to the routing profile; and if not,
forward the message using a flood procedure.

38. A network node for use in a mesh network, the network node comprising a processor and a memory, said memory containing instructions executable by said processor, wherein said network node is operative to:
generate a message; and
insert routing information into the message, the routing information enabling a subsequent node to determine whether the message is to be forwarded according to a routing profile associated with the message, or forwarded using a flood procedure.
